(19) United States
(12) Patent Application Publication
(10) Pub. No.: US 2016/0145887 A1
(43) Pub. Date: May 26, 2016

(54) METHOD FOR THE REALIZATION OF A SURVIVAL MODULE AND SURVIVAL MODULE

(71) Applicant: Matteo GATTO, Reggio di Calabria (IT)

(72) Inventor: Matteo GATTO, Reggio di Calabria (IT)

(21) Appl. No.: 14/900,186

(22) PCT Filed: Jun. 19, 2014
(86) PCT No.: PCT/IT2014/000164

§ 371 Date: Dec. 21, 2015

(30) Foreign Application Priority Data
Jun. 19, 2013 (IT) BO2013A000309

(51) Int. Cl. E04H 9/02; G01M 7/08

(52) U.S. Cl. CPC E04H 9/029; G01M 7/08

(57) ABSTRACT

The invention relates to a method for the realization of a survival module which comprises the following steps: a) forming a prototype of the module provided with a structure theoretically resistant to the stresses determined by the collapse of a building by means of the calculation of the force exerted; b) dispose, within said prototype, measuring instruments capable of recording data relating to acceleration and pressure; c) set a threshold value for the data detected by said measuring instruments; d) placing the prototype so equipped inside or in the vicinity of a building, in an area affected by the collapse or its consequences; e) determine the building to collapse, and: f1) in case of exceeding said threshold value, repeating the design of the prototype; f2) in case of not exceeding said threshold value, using the design data of the prototype for the subsequent production of survival module

The present invention concerns a method for the realization of a survival module usable, in particular, for the protection against damage caused by the collapse of buildings during natural events such as, for example, earthquakes, landslides, etc. The invention relates also to the module realized with the present method.

Over the years, civil engineering has developed increasingly the branch of seismic engineering, to provide that all buildings must meet specific requirements. In particular, it is studied the mechanical response of structures to earthquakes and methods or techniques for the design of buildings with seismic criteria which would hinder the seismic risk, or to adapt to a greater degree of security structures have already been completed, but no longer conform to the seismic codes updated or created subsequent to construction.

The anti-seismic techniques of seismic tend to ensure active protection or preventive material damage and bodily integrity of individuals as opposed to experimental scientific techniques of passive protection or prediction of earthquakes that do not act on damage limitation.

The objective of the design according to seismic criteria, is to provide buildings and other works able to withstand the stresses of earthquakes or at least to collapse in a predetermined manner so as to limit the damage.

The guidelines generally taken at national and international level provide that, especially in the towns, people should try to stay in the home, preferably in areas considered more secure.

In parallel to the studies related to the strengthening of the structures, survival modules of various types have been designed, such as, for example, those described in U.S. Pat. No. 6,349,508, WO 2001/053 632 A1, U.S. 2007/0296605 A1.

The survival modules described by the prior art are generally defined as “resistant” to the forces incurred as a result of the earthquake. In practice, the known survival modules are configured with purely theoretical assessments that take into account real parameters, such as size and weight of the building equipped, but provide design data which remain in the calculation field.

Aim of the present invention is to provide a method for the realization of survival modules, and a survival module, able to solve the drawbacks of the prior art with a new solution that allows the realization of survival modules in a way which is extremely precise and substantially corresponding and sized to situations that may occur in the actual event occurring naturally.

This result is achieved, according to the invention, by adopting the idea of providing a method and a module having the features described in the independent claims. Other features are described in the dependent claims.

Among the advantages of the present invention may be listed those described below. It is possible to offer a protection which is effective and proven in similar situations corresponding to the real ones.

The structure of the survival module thus obtained can be used in new buildings and/or to fit out existing buildings.

The module can be integrated in a usual home or office without significantly altering the intended use, functionality, aesthetics, being able to make the external appearance of the form similar to the environment in which it is inserted.

The survival module of the invention can be used in different fields such as, for example, residential houses, schools, factories, public and private offices, sporting structures, hotels and similar.

These and other advantages and features of the present invention will be best understood by anyone skilled in the art from the following description and with the help of the attached drawings given as a practical exemplification, but not to be considered in a limiting sense, in which:

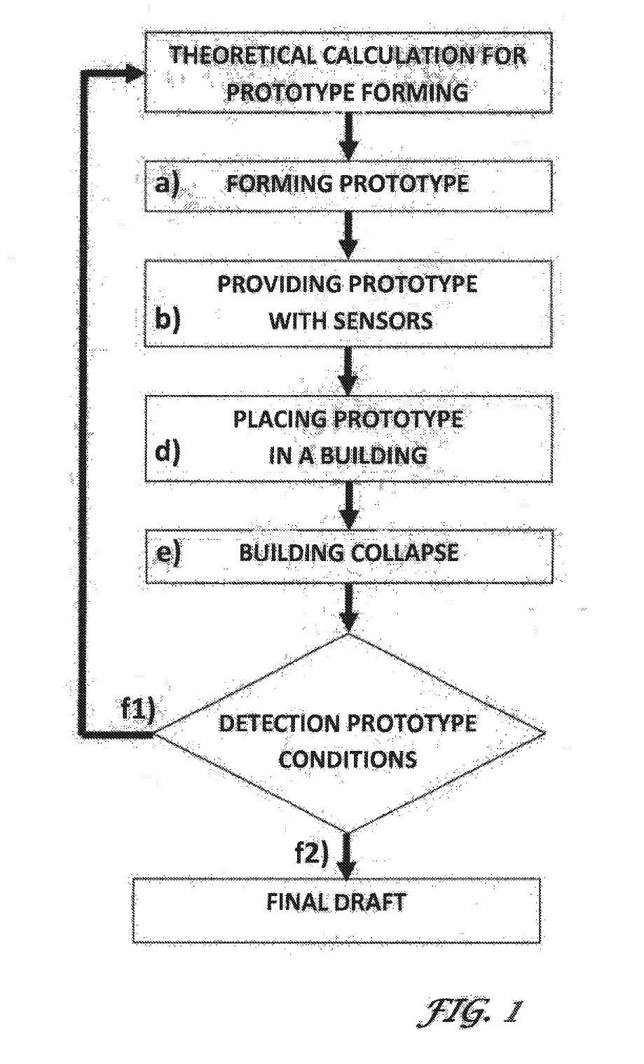

FIG. 1 relates to a block diagram that represents a possible embodiment of a method for the realization a survival module according to the invention;

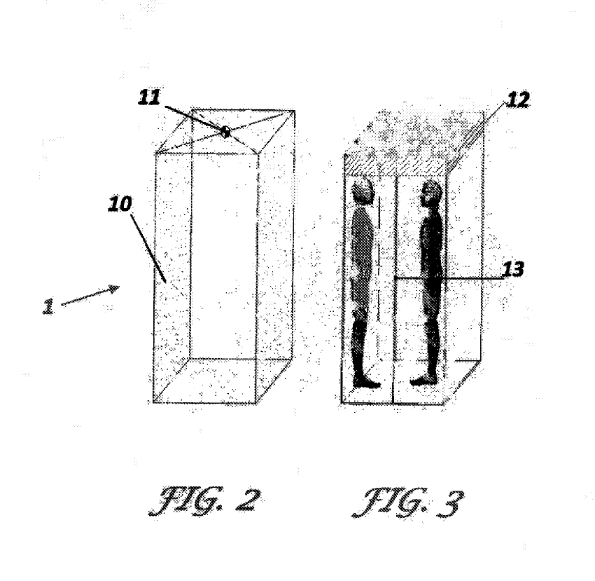

FIGS. 2 and 3 are two schematic perspective views of a possible embodiment of the module of the invention;

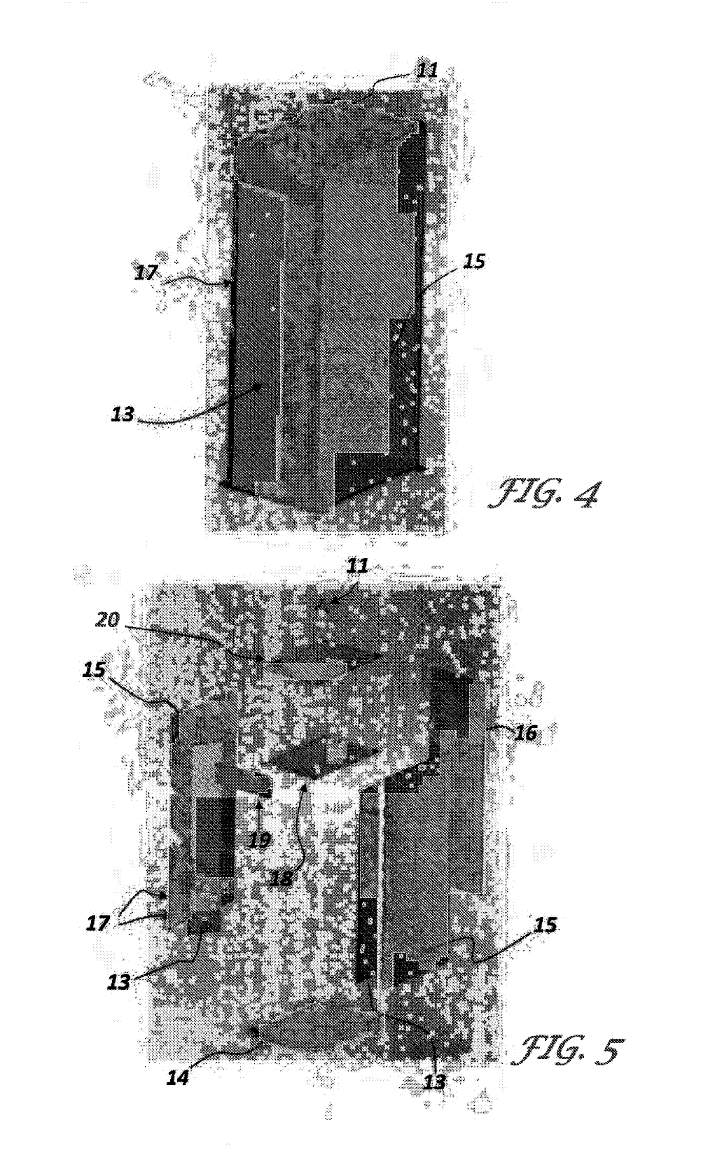

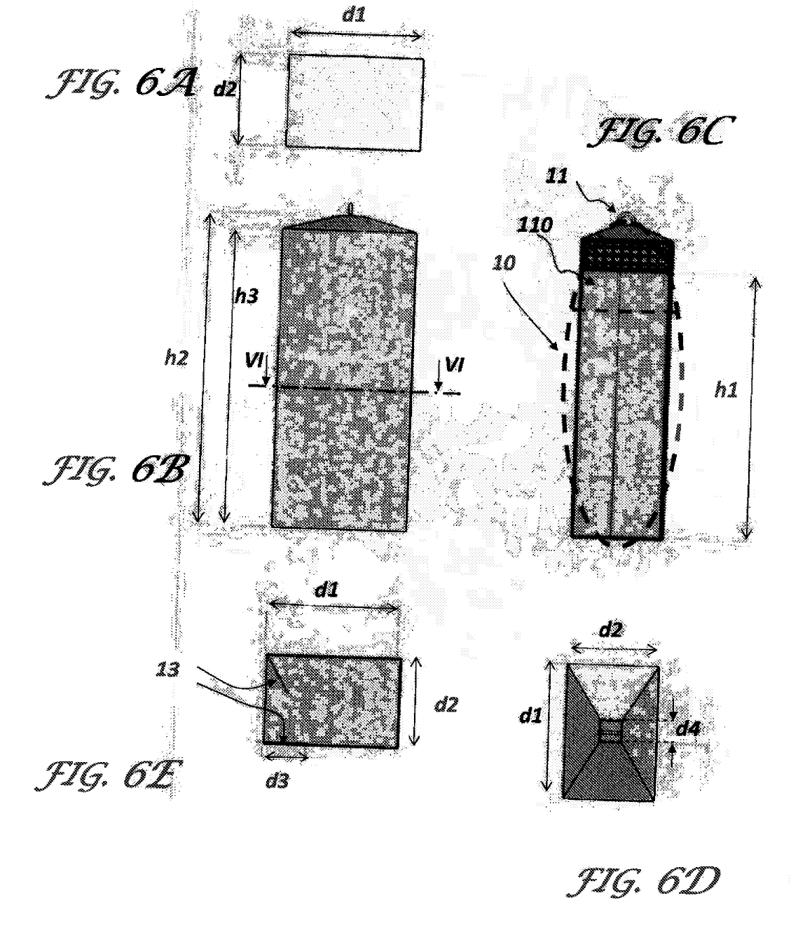

FIGS. 4, 5, 6A-E relate to another possible embodiment of the module; in particular, FIG. 4 is a perspective view of the whole, FIG. 5 is an exploded view, FIG. 6A is a view from below, the FIG. 6B is a side view, FIG. 6C is a front view, FIG. 6D is a top view, FIG. 6E is a view in section along the line VI-VI of FIG. 6B.

With reference to the accompanying drawings which, as stated above, represent only possible embodiments, a method according to the invention comprises the following steps:

a) forming a prototype of the module provided with a structure theoretically resistant to the stresses determined by the collapse of a building by means of the calculation of the force exerted to the module based on static and dynamic parameters of the building subjected to the forces of the natural event;
b) dispose, within said prototype, measuring instruments capable of recording data relating to acceleration and pressure inside the prototype;
c) set a threshold value for the data detected by said measuring instruments corresponding to a suitable value to ensure the survival of a living being placed inside the said module;
d) placing the prototype so equipped inside or in the vicinity of a building, in an area affected by the collapse or its consequences;
e) determine the building to collapse, and:
f1) in case of exceeding said threshold value, repeating the design of the prototype increasing the values relating to the strength or otherwise modifying the calculation of the design of the prototype compared to that was tested;
f2) in case of not exceeding said threshold value, using the design data of the prototype for the subsequent production of survival module.

In practice, the first phase (marked a) is preceded by a calculation by means of a theoretical calculation adapted to determine the characteristics which the survival module must have to withstand without damage (or with damage to the structure such as not to cause serious harm to people contained). For the execution of the calculation, it may take into account such values as the weight of the building, its structure, any areas most likely to collapse, the arrangement of the module with respect to the building (floor number, proximity to the support structure, etc. . . . ).

The structure (10) of the survival module (1) can be made of a material with high mechanical resistance to stresses such as, for example, titanium, steel, carbon, or combinations of these materials.

Superiorly, the module (1) may be provided with a ring (11) to be lifted and moved; furthermore, its doors (13), which may preferably be one or two doors, will be provided with hinges particularly strong so as not to weaken the module (1) in correspondence of the door. The module (1) can be provided with suitable means for storing and dispensing the oxygen and/or potable water; such means are schematically represented in FIG. 3 by the upper zone (12) of the module (1).

The module, preferably, will be sized so as to be able to contain two persons; in this way it is possible to obtain optimal structural characteristics. For containment of more than two people, combinations of more modules will be provided.

As stated above, according to the step b), appropriate measuring instruments have to be disposed within the prototype: these instruments can advantageously comprise crash-test dummies. In practice, within the module can be inserted one or more dummies, presenting a proper weight and the joints to simulate the behavior of a human body; said dummies being provided with instrumentation to record the highest number of possible data on the variables relating to the impact with parts of the building during the collapse as, for example, the impact speed, the crushing forces, bending or torsion of the body and the deceleration upon impact and subsequently.

In practice, the testing of the module is obtained by means of one or more prototypes, in order to provide a result relative to the real and objective measurement of the degree of safety of the bodies present within the survival module. This allows, in other words, to certify the conditions of “livability” secured inside the module during the collapse of the building.

The prototype of the module is subjected to the reproduced effects of the natural event by means of crash test simulators of customary use in the design of automotive chassis. In the execution phase (real and not virtual) the testing can be realized through the so-called “controlled demolition of big buildings”, which is the usual technique used to raze to the ground impressive residential complex or large industrial conglomerates now old or for not allowed building. In fact, when one or more prototypes are disposed on different floors, it is possible to test both the structural capacity and safety of the same module, and verify the degree of resistance particularly in extreme conditions of use. Furthermore, during these testing phases, by means of sensors (accelerometers, pressure gauges, etc. . . . ), it is possible to measure the effects produced within the module by the collapse of the structural elements at the different floors and especially the resistance to crushing caused by significant and measurable-preventively-quantity of building materials (concrete, iron, etc. . . . ).

The module (1) can advantageously be provided with additional means of damage limitation such as integral safety belts and airbags; integral safety belts being those that can also offer protection to the neck area.

Moreover, in addition to the reserves of air and/or water mentioned above, the module may be provided with reserves of electricity and/or means for emitting a localization signal and/or means of wireless communication. The location signal can be of sound and/or light and/or radio type.

The use of the module of the present invention is not limited to earthquakes, but may be extended to other types of catastrophic events such as tsunamis, tornados, floods, etc. . . . , possibly modifying its ability to impermeability and resistance to different external conditions them. For cases in which it can be expected to contact with the water, the module will be airtight resulting liquid impermeable.

In FIGS. 4 and 5 is shown another possible embodiment of the invention. In this case, the module (1) is formed by a series of panels joined together, for example by welding. In particular, the module (1) comprises a rectangular quadrilateral base (14), to which are associated two side walls (15), a bottom wall (16); the module (1) further comprising an intermediate element (18) arranged parallel to the base (14) and a top cover or roof (20).

Advantageously, the roof (20) is inclined to better withstand the stresses resulting from the fall of rubble and to be able to offer a lower resistance in a possible movement in respect to the structure of the building in which is inserted the module (1). On the roof (20) is also fixed the ring (11), in a similar way to that for the FIG. 2.

The intermediate element (18) defines the compartment marked with (12) in the example of FIGS. 2 and 3, compartment intended to contain the means for the conservation of the air and/or water and/or for instrumentation. In front, the module (1) is closed by an element (19) in correspondence of the compartment (12) arranged above; lower, it is closed by a double door (13), which are connected to the side walls (15) by means of very strong hinges (13).

Referring to the drawings of FIGS. 4, 5, and 6A-E, but not limited to the following values may be used: d1 about 900 mm, d2 about 600 mm, d3 about 300 mm, d4 about 150 mm, h1 about 1800 mm, h2 about 2100 mm, h3 approximately 2000 mm.

In the testing phase the use of carbon fiber for the construction of the module (1) appeared as particularly recommended. In addition, studies have shown that a structure (10) of substantially oval form (1) (schematically indicated with dashed lines in FIG. 6c) offers improved resistance to stress and leads to a better interaction with any fragments or debris flows that stand out from the building in which the module is installed. In other words, it appears preferable to have a structure in the form of egg in monocoque carbon fiber with an access opening closed by a door. The upper portion of the module, indicated with (110) in FIG. 6c, will preferably be characterized by an increased resistance to stress; for example could be realized with a greater thickness than the remaining part of the module. Considerable advantages are obtained also with regard to the weight of the module (1) that, in this way, can be kept lower. A module (1) weight content can be more easily positioned with respect to the building structure in which it is installed.

Another feature of the module (1) of the invention is its customization with possibility of changing the external appearance as a function of the environment in which it is inserted.

For example, the module (1) can have the doors (13) made in a manner similar to the fixtures of the house in which it is disposed, so as to be consistent with the decor. The same doors (13) can be covered with mirrored surfaces to be more pleasing to the eye. In practice, the external appearance of the module is turned to allow a better insertion in the environment in which it is housed.

Naturally, the invention is not limited to those described and illustrated, but can be widely varied with regard to the nature and arrangement of the materials used, without departure from the inventive teaching above described and claimed below.

1) Method for the realization of a survival module usable, in particular, for the protection against damage caused by the collapse of buildings during natural events characterized in that it comprises the following steps:
a) forming a prototype of the module provided with a structure theoretically resistant to the stresses determined by the collapse of a building by means of the calculation of the force exerted to the module based on static and dynamic parameters of the building subjected to the forces of the natural event;
b) dispose, within said prototype, measuring instruments capable of recording data relating to acceleration and pressure inside the prototype;
c) set a threshold value for the data detected by said measuring instruments corresponding to a suitable value to ensure the survival of a living being placed inside the said module;
d) placing the prototype so equipped inside or in the vicinity of a building, in an area affected by the collapse or its consequences;
e) determine the building to collapse, and:
f1) in case of exceeding said threshold value, repeating the design of the prototype increasing the values relating to the strength or otherwise modifying the calculation of the design of the prototype compared to that was tested;
f2) in case of not exceeding said threshold value, using the design data of the prototype for the subsequent production of survival module.

2) Method according to claim 1 characterized in that said step b) is performed using one or more crash test dummies.

3) Method according to claim 1 characterized in that said step b) is performed using one or more crash test dummies bound to the structure of the prototype using integral safety belts, the prototype being provided with at least one airbag device.

4) Method according to claim 1 characterized in that the structure of the prototype is made of a material chosen among steel, carbon, titanium and combinations thereof.

5) Survival module usable, in particular, for the protection against damage caused by the collapse of buildings during natural events characterized in that it is made according to a method described in claim 1.

6) A module according to claim 5 characterized in that it is provided with integral safety belts for the occupants and/or airbag and/or reserves of air and/or reserves of electricity and/or means for emitting a localization signal and/or means of wireless communication.

7) Module according to claim 6 characterized in that the localization signal is a sound and/or light and/or radio signal.

8) Module according to claim 5, characterized in that it is equipped with a hook to facilitate the recovery and/or the disposal in use.

9) Module according to claim 5, characterized in that it is airtight, so to result liquid impermeable.
